(19) United States
(12) Patent Application Publication
(10) Pub. No.: US 2019/0091506 A1
(43) Pub. Date: Mar. 28, 2019

(54) DEVICE FOR THE ASSISTED EXECUTION OF A PHYSICAL EXERCISE BY A USER

(71) Applicant: PROMEGA S.r.l., Botticino Sera, Brescia (IT)

(72) Inventors: Gualtiero GATELLI, Botticino Sera, Brescia (IT); Luca GATELLI, Botticino Sera, Brescia (IT); Stefania GATELLI, Botticino Sera, Brescia (IT)

(73) Assignee: PROMEGA S.r.l., Botticino Sera, Brescia (IT)

(21) Appl. No.: 16/085,281

(22) PCT Filed: Feb. 23, 2017
(86) PCT No.: PCT/IB2017/051028

§ 371 Date: Sep. 14, 2018

(30) Foreign Application Priority Data
Mar. 15, 2016 (IT) 102016000026895

(51) Int. Cl. A63B 21/00; A63B 71/00; A63B 21/22; A63B 24/00; A63B 22/00; A63B 21/005; A63B 21/015; A63B 22/06; A61H 1/02

(52) U.S. Cl. CPC A63B 21/00178; A61H 2205/10; A63B 21/225; A63B 21/4034; A63B 21/4035; A63B 24/0087; A63B 22/0012; A63B 21/00181; A63B 21/0058; A63B 21/015; A63B 22/0005; A63B 22/0605; A61H 1/0214; A61H 1/0237; A61H 1/0274; A63B 2225/093; A63B 2208/0228; A63B 2071/0081; A61H 2201/1635; A61H 2201/164; A61H 2201/1671; A61H 2201/1215; A61H 2205/06; A63B 71/0054

(57) ABSTRACT

A device (1) for the assisted execution of a physical exercise by a user includes a sitting area (2) in which the user is accommodated. Leg movement devices (3) are suitable for accommodating the right and left foot, respectively, of the user to move them according to a rotatory trajectory with respect to a leg rotation axis (G-G). Arm movement devices (4) are graspable by the user with the right and left hand, respectively, to move them according to a rotatory trajectory with respect to an arm rotation axis (B-B) that extends parallel to the leg rotation axis (G-G). The device further includes an exercise controller (5) operatively connected to the leg movement devices (3) and to the arm movement devices (4) to transmit the respective movement simultaneously.

The object of the present invention is a device for the assisted execution of a physical exercise by a user.

In particular, the device of the present invention is suitable for simultaneously moving both the lower limbs (the legs) and the upper limbs (the arms) of the user. In particular, the device of the present invention allows the on-the-spot execution of the physical exercise, for example in order to be used within an indoor context.

A plurality of devices suitable for allowing the execution of specific on-the-spot movements are known in the prior art.

For example, devices are known for sitting workouts, such as “classic stationary bikes” or “arm exercise bikes”: classic stationary bikes are used to execute lower limb rotational movement workouts, while “arm exercise bikes” are used to execute upper limb rotational movement workouts.

Additionally, upright workout devices are known, such as the stepper or the wave, on which the lower limbs press during the workout.

The problem with the devices mentioned above is that the physical exercise is only focused on certain specific muscle groups.

Moreover, workout devices are known such as the “elliptical bike”, on which the user, who is standing up, moves both arms and legs with movements which are substantially similar to those of running.

Although they allow the movement both of the upper limbs and the lower limbs, the problem with such devices is that the user is forced to take on a particularly physically probative and typically uncomfortable position.

It is therefore the object of the present invention to provide a variant of known devices, which is suitable for causing the movement of the upper and lower limbs simultaneously, thus allowing the user to maintain a more comfortable position that is not too probative.

Such an object is achieved by a device for the assisted execution of a physical exercise by a user, made according to claim 1.

Further advantages and features of the device of the present invention are protected by the dependent claims.

The features and further advantages of the device according to the present invention will also become apparent from the following description, given by way of a non-limiting example, according to the accompanying drawings, in which:

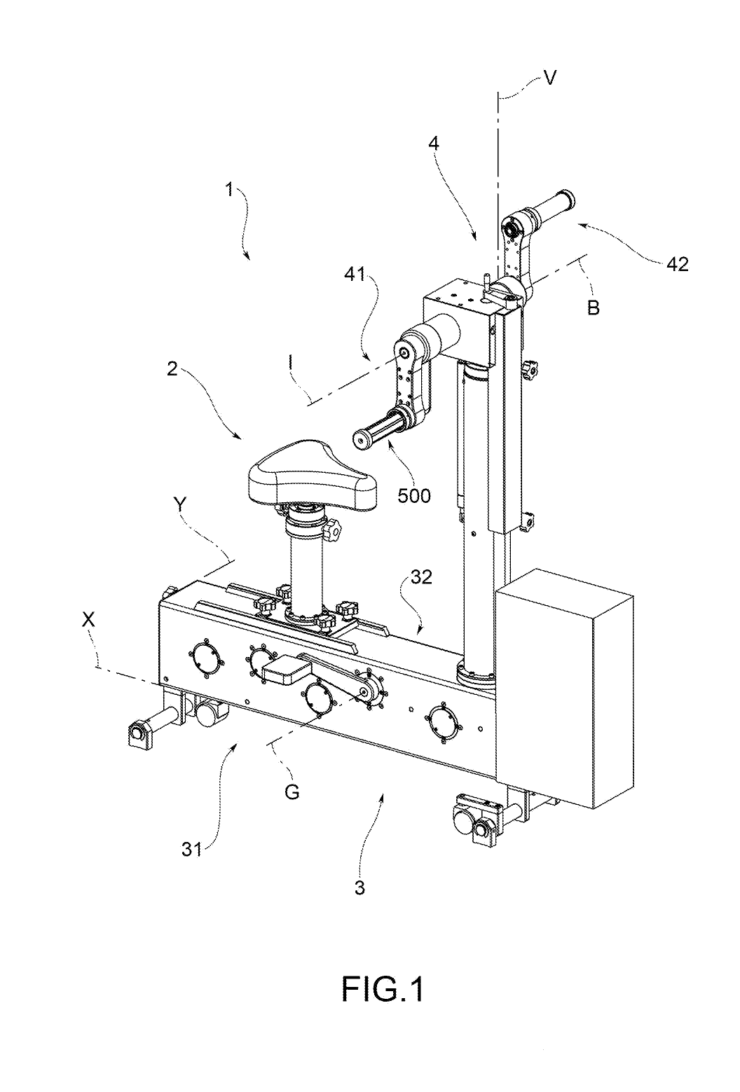

FIG. 1 shows a perspective view of the device of the present invention, according to a preferred embodiment;

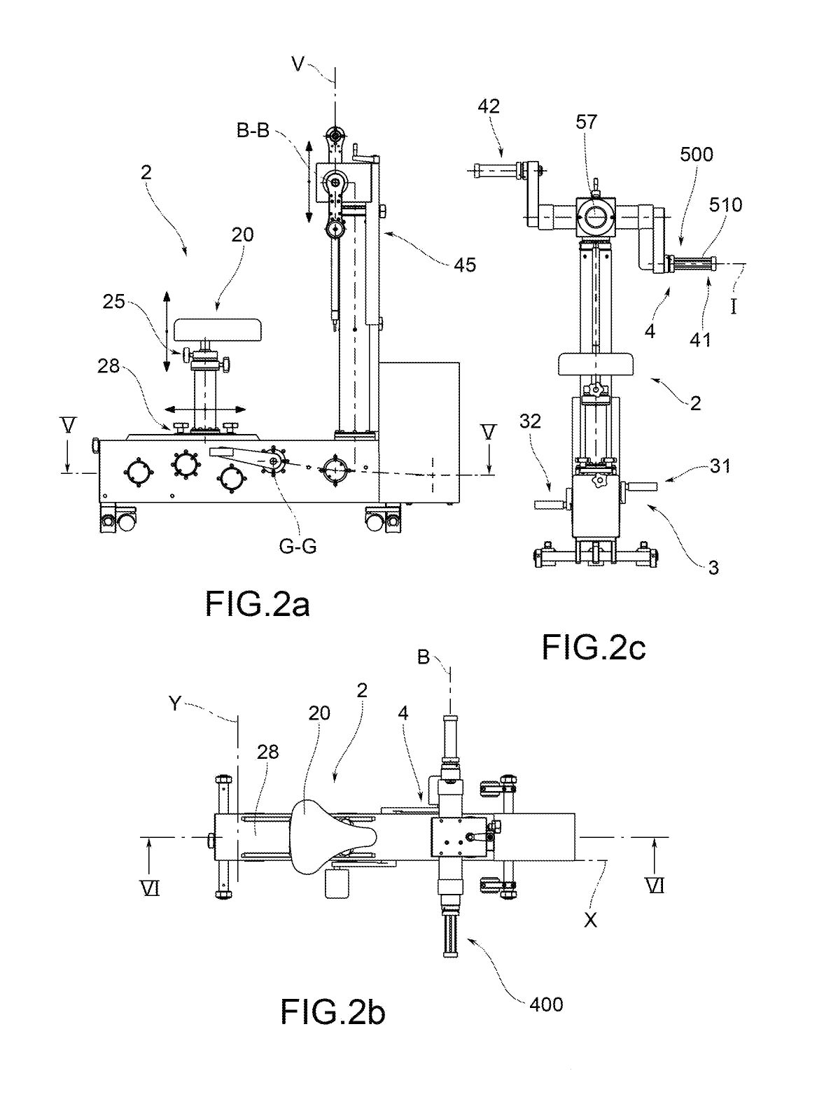

FIGS. 2a, 2b and 2c show a side view, a top view and a back view, respectively, of the device in FIG. 1;

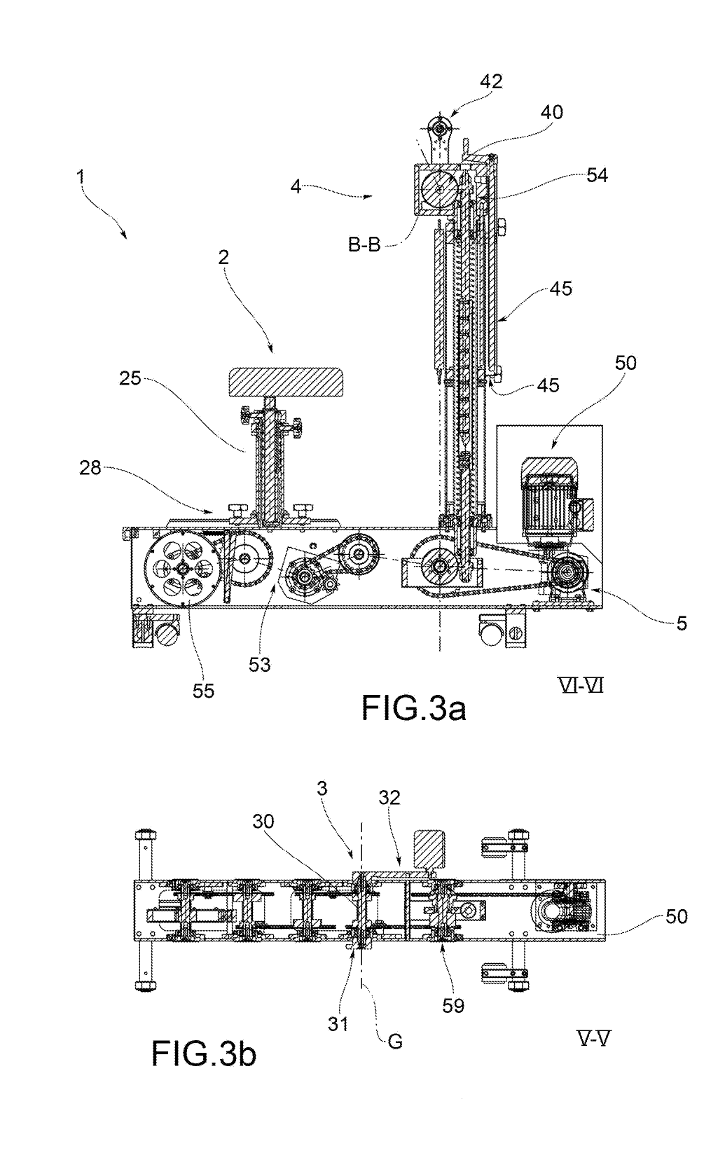

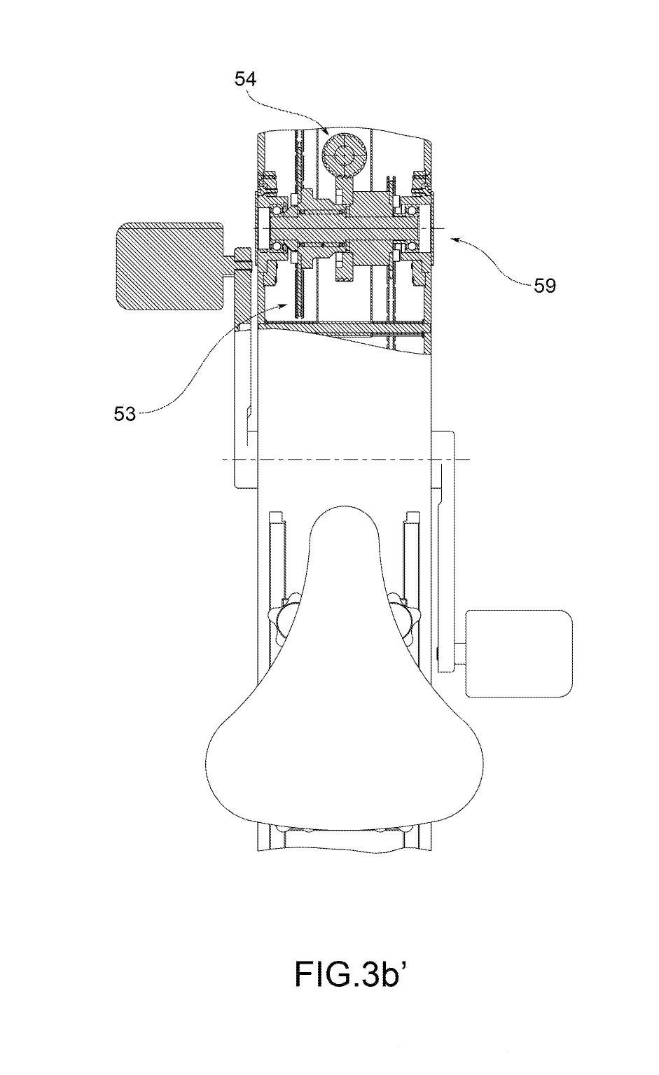

FIGS. 3a and 3b depict two sections of the device along the sectional planes VI-VI and V-V, respectively, of the FIGS. 2a and 2b;

FIG. 3b′ shows an enlarged portion of the figure in FIG. 3b;

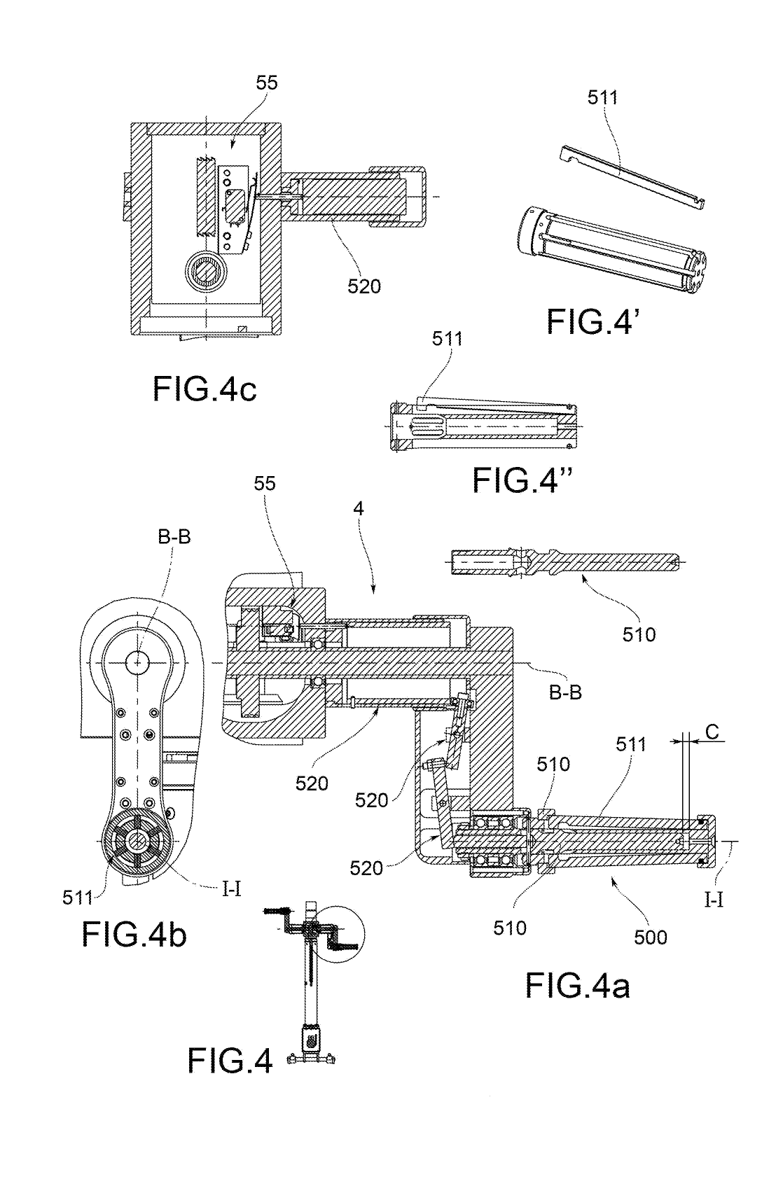

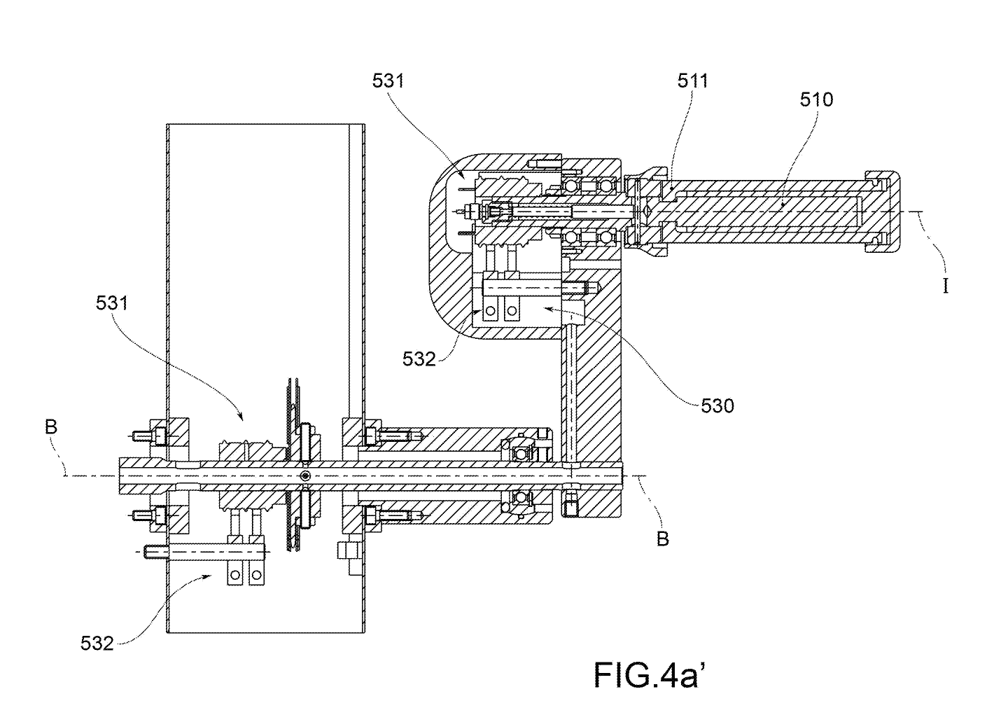

FIGS. 4, 4a, 4b and 4c show sectional and enlarged views, respectively, of an on-off grip comprised in the device according to a preferred embodiment;

FIG. 4a′ instead depicts a sectional view of an on-off grip comprised in the device according to a further preferred embodiment;

FIGS. 4′ and 4″ show a perspective view with separate parts and a sectional view, respectively, of certain components comprised in an on-off grip, like the one shown in FIGS. 4, 4a, 4b, 4c and 4a′;

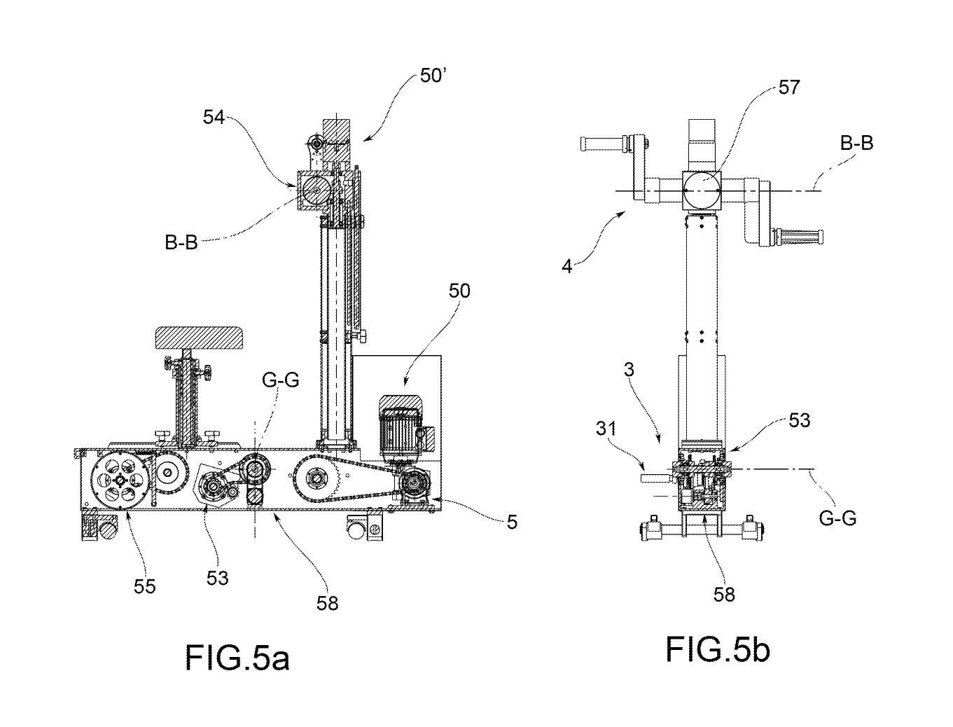

FIGS. 5a and 5b depict two sections of the device, respectively, along the sectional plane VI-VI similarly to FIG. 3a and along the sectional plane L-L shown in 5a, respectively, with reference to a further embodiment thereof;

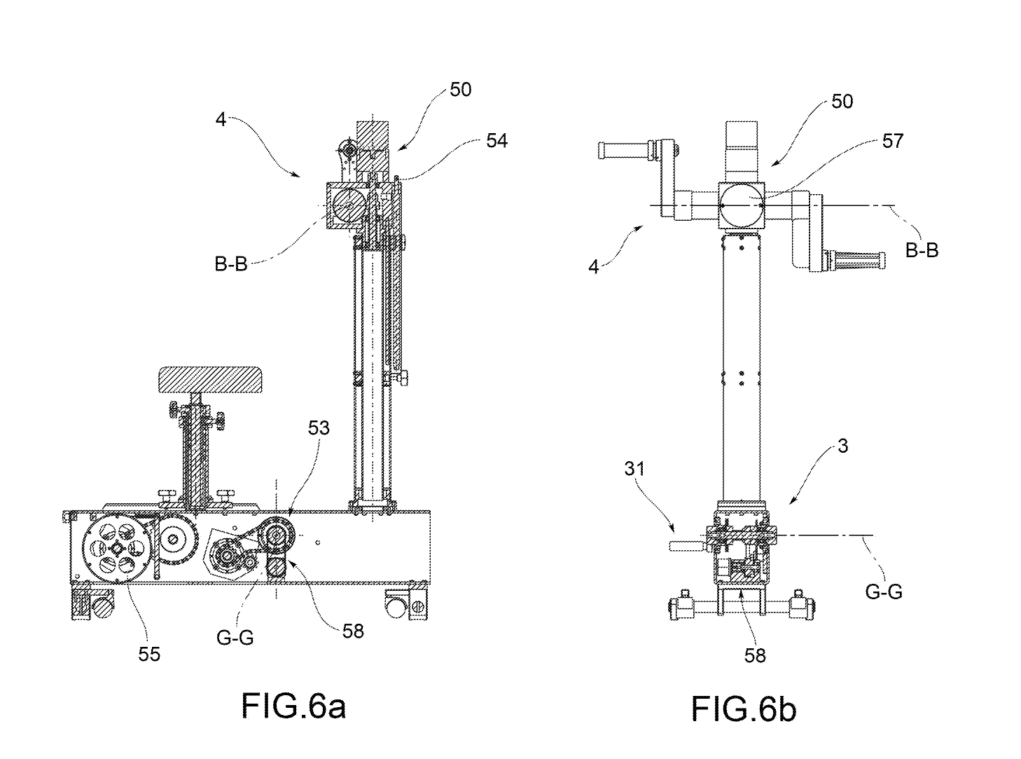

FIGS. 6a and 6b depict two sections of the device, respectively, along the sectional plane VI-VI similarly to FIG. 3a and along the sectional plane M-M shown in 6a, respectively, with reference to a further embodiment thereof again;

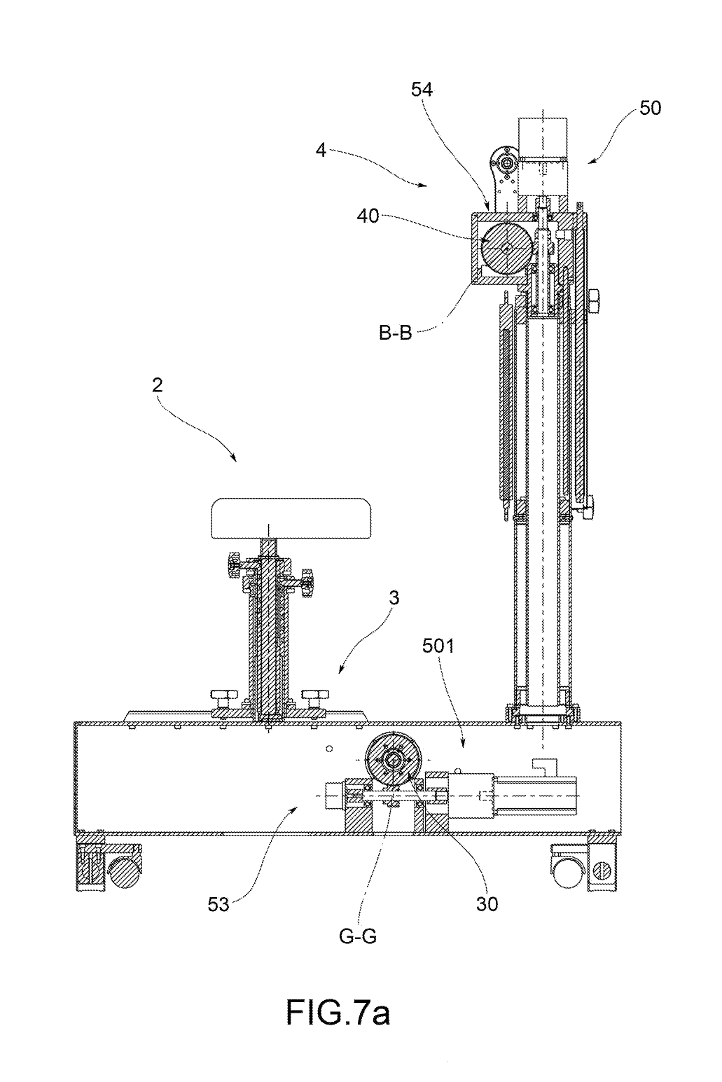

FIG. 7a shows a section of the device along the sectional plane VI-VI, respectively, similarly to FIG. 3a with reference to a yet another embodiment;

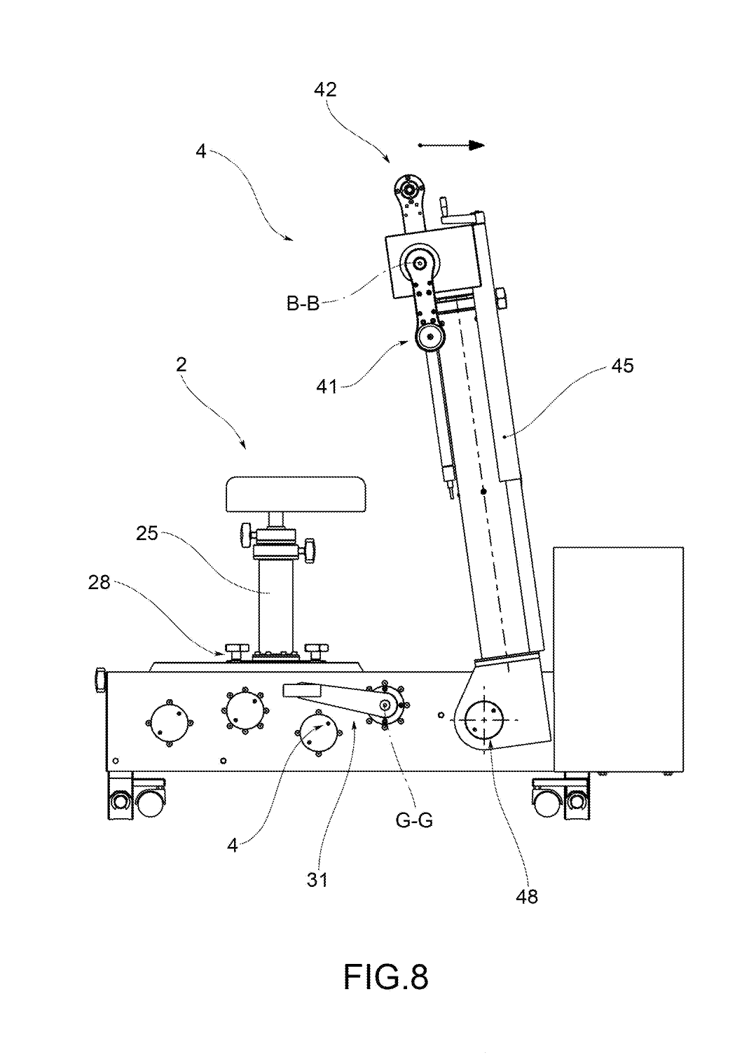

FIG. 8 shows a side view of a device according to a further embodiment.

A device for the assisted execution of a physical exercise by a user is indicated with numeral 1 in the accompanying drawings.

Preferably, device 1 is suitable for being arranged on a ground resting plane T and identifies a longitudinal axis X-X, a transverse axis Y-Y and a vertical axis V-V.

Device 1 comprises a sitting area 2 in which the user is accommodated. In one embodiment, the sitting area 2 allows the user to be accommodated, for example with a chair or a wheelchair. While in a preferred embodiment (described below), device 1 comprises a saddle 20 in the sitting area 2, on which the user is accommodated.

Moreover, device 1 comprises leg movement means 3 comprising a right pedal group 31 and a left pedal group 32, which are suitable for accommodating the right foot and the left foot of the user, respectively, to move them according to a rotatory trajectory with respect to a leg rotation axis G-G.

Additionally, device 1 comprises arm movement means 4 comprising a right handle group 41 and a left handle group 42 graspable by the user with the right hand and the left hand, respectively, to move them according to a rotatory trajectory with respect to an arm rotation axis B-B.

Preferably, said arm rotation axis B-B extends parallel to the leg rotation axis G-G.

Preferably, the arm rotation axis B-B and leg rotation axis G-G extend parallel to the transverse axis Y-Y. Moreover, the arm rotation axis B-B preferably extends along the vertical axis V-V at a different height with respect to the leg rotation axis G-G. Additionally, the arm rotation axis B-B preferably is longitudinally spaced apart from the leg rotation axis G-G along the longitudinal axis X-X.

According to a preferred embodiment, the leg movement means 3 comprise a leg rotation shaft 30 at whose ends the right pedal group 31 and the left pedal group 32 are connected; similarly, the arm movement means 4 comprise an arm rotation shaft 40 at whose ends the right handle group 41 and the left handle group 42 are connected. That means, said leg rotation shaft 30 and said arm rotation shaft 40 extend along the leg rotation axis G-G and along the arm rotation axis B-B, respectively.

According to a preferred embodiment, right pedal group 31 and left pedal group 32 are similarly configurable diametrically opposite to the leg rotation axis G-G; in other words, right pedal group 31 and left pedal group 32 are configurable in such a manner that they rotate in antiphase. According to another preferred embodiment, right pedal group 31 and left pedal group 32 are configurable arranged at the same angle with respect to the leg rotation axis G-G; in other words, right pedal group 31 and left pedal group 32 are configurable in such a manner that they rotate in phase.

According to a preferred embodiment, right handle group 41 and left handle group 42 are similarly configurable diametrically opposite to the leg rotation axis G-G; in other words, right handle group 41 and left handle group 42 are configurable in such a manner that they rotate in antiphase. According to another preferred embodiment, right handle group 41 and left handle group 42 are configurable arranged at the same angle with respect to the leg rotation axis G-G; in other words, right handle group 41 and left handle group 42 are configurable in such a manner that they rotate in phase.

Device 1 further comprises exercise control means 5 operatively connected to the leg movement means 3 and to the arm movement means 4 to transmit the respective movement simultaneously.

In other words, the movement of legs and arms of the user is always carried out in a synchronous manner using the exercise control means 5.

That means, the control means 5 are operatively connected to the leg rotation shaft 30 and to the arm rotation shaft 40 to move them in rotation.

In a preferred embodiment, device 1 is suitable for allowing the movement of arms and legs both by user action and by action guided by the exercise control means 5. In other words, the exercise control means 5 are suitable both for receiving the action of the movement by the user and vice versa, they are suitable for imposing such a movement on the user.

Preferably, the exercise control means 5 comprise an electric motor group 50 operatively connected with the leg movement means 3 and the arm movement means 4 to control the respective movement thereof.

According to a preferred embodiment, the electric motor group 50 is of the alternating current asynchronous type.

In a preferred embodiment, the control means 5 comprise a leg transmission group 53 operatively connected to the leg rotation shaft 30.

In particular, the leg transmission group 53 comprises belts or chains or gears for transmitting the rotational motion from or towards the pedal groups. The leg transmission group 53 comprises a plurality of belts or chains or gears, engaged with rotation shafts and/or gears, respectively, as shown for example in the accompanying drawings (in a non-limiting embodiment).

According to a preferred embodiment, the exercise control means 5 comprise an arm transmission group 54 operatively connected to the arm rotation shaft 40.

In particular, the arm transmission group 54 comprises belts or chains or gears and/or an element comprising cylindrical wheels with helical gear teeth or conical wheels for transmitting the rotational motion from or towards the handle groups. The arm transmission group 54 comprises a plurality of belts or chains or gears or elements comprising cylindrical wheels with helical gear teeth or conical wheels engaged with rotation shafts and pulley elements and/or gears, respectively, as shown for example in the accompanying drawings (in a non-limiting embodiment).

According to a preferred embodiment, leg transmission group 53 and arm transmission group 54 are operatively connected with each other in such a manner as to ensure the synchronous movement of pedal groups and handle groups.

According to a preferred embodiment, the electric motor group 50 is operatively connected to the leg transmission group 53 and to the arm transmission group 54.

In a preferred embodiment, the exercise control means 5 comprise a free wheel 59 suitable for operatively connecting the electric motor group 50 to the leg transmission group 53 and the arm transmission group 54.

For example, in a preferred embodiment, the leg transmission group 53 and the arm transmission group 54 are operatively connected with gears and telescopic drive shaft or by a dual cardan joint or with belts and chains.

Preferably, the leg transmission group 53 and the arm transmission group 54 are movable in rotation by the electric motor group 50 or upon pushing by the user, through the coupling with the free wheel 59; in other words, the leg transmission group 53 and the arm transmission group 54 are movable manually by the user or in a guided manner by the electric motor group 50 due to the free wheel 59.

According to a preferred embodiment, the exercise control means 5 comprise a flywheel element 55 moved in rotation by the movement of the leg movement means 3 and the arm movement means 4. In a preferred embodiment, the flywheel element 55 is arranged in proximity of the leg movement means 3, preferably is comprised in the leg transmission means 53, for example is moved by means of the belts and/or chains or gears comprised in said leg transmission means 53.

Preferably, device 1 comprises flywheel braking means operatively connected with the flywheel element 55 and adjustable by the user to brake the movement of the flywheel and adjust the resistance to the movement of the user, preferably both of the leg movement means 3 and the arm movement means 4.

A multiplicity of embodiments of device 1 are also provided, comprising different embodiments of the control means 5, which in turn are shown by way of example in the accompanying drawings.

For example, embodiments may be provided in which the control means 5 comprise an encoder 58 operatively connected to the leg transmission group 53, in which said encoder 58 communicates with a secondary electric motor 50′ (in turn provided with a secondary encoder) operatively connected to the arm transmission group 54 (as shown in FIGS. 5a and 5b) to adjust the synchronous rotation of the respective movement means.

Or other embodiments again, in which the control means 5 comprise an encoder 58 operatively connected to the leg transmission group 53 suitable for being controlled on signal of the electric motor group 50 (in turn provided with a control transmitting encoder for the two-way communication with encoder 58), in which the electric motor group 50 is operatively connected to the arm transmission group 54 (as shown in FIGS. 6a and 6b); in this manner, the movement of the respective movement means is, again, actuated synchronously.

Or in further embodiments, the control means 5, and in particular the electric motor group 50, comprises a pair of brushless motors 501 operatively connected to each other by a pair of encoders suitable for synchronously guiding the movement of the leg transmission group 53 and the arm transmission group 54 (as shown in FIG. 7a), respectively; the movement of the respective movement means is actuated synchronously also in this case.

According to a preferred embodiment, the control means 5 comprise an on-off grip 500 by means of which the user controls turning on and moving the leg movement means 3 and the arm movement means 4.

In other words, said on-off grip 500 is accommodated in the right handle group 41 and/or in the left handle group 42. That means, said on-off grip 500 substantially is the knob which is graspable by the user.

In particular, said on-off grip 500 indeed is operatively connected to the electric motor group 50 in such a manner that the electric motor group 50 is turned on or off, respectively, by the action of the user thereon.

Preferably, the on-off grip 500 is actuatable by the user so as to be configurable, starting from an off configuration in which the electric motor group 50 is turned off, to an on configuration in which the electric motor group 50 is turned on and moves the leg movement means 3 and the arm movement means 4.

In particular, the on-off grip 500 is axially and radially actuatable by user action.

Preferably, the on-off grip 500, indeed, comprises at least one button portion 510 yieldable in axial direction when pressed by the user and suitable for triggering the electrical contact that controls the electric motor group 50. In other words, the button portion 510 is axially pushable with respect to the grip axis I-I by user action.

According to a preferred embodiment, the on-off grip 500 cooperates with mechanical on-off means 520 in turn comprised in the exercise control means 5, which are suitable for mechanically transmitting the action undergone by the button portion 510 up to engaging an electrical push-button element 55 operatively connected to the electric motor group 50.

In other words, the mechanical on-off means 520 consist of a plurality of mechanical linkages actuated by the movement of the button portion 510 so as to transmit the action of the user starting from grip 500 up to an electrical push-button element 55 operatively connected to the electric motor group 50.

Preferably, the mechanical linkages 520 are suitable for undergoing an elastic pushing action by the electrical push-button element 55 and for transmitting such an action up to the button portion 510 to keep the latter in the axial position corresponding to the off configuration of grip 500. In other words, the action by the user on grip 500 should overcome said elastic action induced by the electrical push-button element 55 which keeps it in off configuration.

Moreover, in a preferred embodiment, the on-off grip 500 is provided with at least one radial lever 511 (preferably it is provided with six radial levers 511 equally spaced apart from one another) which extends along the grip axis I-I and is radially pushable by the user to complete the positioning of grip 500 in the on configuration. In other words, grip 500 is controlled by the user from the off to the on configuration, after a first axial action and a second radial action.

Preferably, the radial lever 511 engages the button portion 510 in such a manner as to assist it in overcoming the elastic action it exerts thereon. For example, the radial lever 511 and the button portion 510 are mutually engaged with each other through specific locking teeth, the interaction of which is suitable for helping the user overcome the elastic return action.

However, such locking teeth are sized to allow the elastic action acting on the button portion 510 to allow the return of crank 500 to said off configuration when there is no action by the user on grip 500.

In other words, by grasping the respective handle group 41, 42, the user should execute a continuous action on grip 500 to keep the electric motor group 50 turned on.

Therefore, the linkages system preferably is suitable for being actuated by the button portion 510 in any radial position grip 500 is in with respect to the arm rotation axis B-B. The actuation of the electric motor group 50 is therefore ensured over time by the mechanical on-off means 520.

According to a further embodiment, electrical on-off means 530 are provided in place of the mechanical on-off means 520, for example comprising at least one electric collector 531 operatively connected with an electric brush 532, in such a manner that the control signal is carried to the electric motor group 50 upon actuation of the button portion 510 and by means of said electrical on-off means 530. In such an embodiment, the action of the user on crank 500 results in a control to the electrical on-off means 530 by means of the at least one electric collector 531 and of the at least one electric brush 532.

According to a preferred embodiment, the control means 5 further comprise a safety switch 57 preferably arranged in a position proximal to the arm movement means 4 (for example, in a position comprised between right handle group 41 and left handle group 42), which is operatively connected to the electric motor group 50 so that once pressed, the electric motor group 50 is turned off and the movements of the leg movement means 3 and of the arm movement means 4 are blocked.

That means, the electric motor group 50 is suitable for turning off when it is not actuated by grip 500, but in the event of an emergency, also by an action on the safety switch 57.

According to a preferred embodiment, device 1 is configurable and adjustable for use by users having different dimensions, e.g. of different heights or according to the length of their limbs.

Preferably, the arm movement means 4 comprise a height adjustment element 45 through which the position of the arm rotation axis B-B, and therefore of the right handle group 41 and of the left handle group 42, is adjustable to a predefined height.

In other words, the height adjustment element 45 makes the arm rotation axis B-B positionable at a preferred height along the vertical axis V-V.

Preferably, the height adjustment element 45 comprises a crank group, the rotation of which adjusts the height position of the arm rotation axis B-B.

Moreover according to a preferred embodiment, the arm movement means 4 comprise a distance adjustment element 48 through which the longitudinal distance between the sitting area 2 and the arm rotation axis B-B, is adjustable.

In other words, the distance adjustment element 48 makes the arm rotation axis B-B positionable at a predefined distance along the longitudinal axis X-X.

According to a preferred embodiment, the arm transmission means 54 are structured in such a manner as to allow the variation in height and in distance of the arm rotation axis B-B; in particular, belts and/or chains and the respective gears and rotation shafts and pulley elements are designed to allow such variations, for example by modifying the position of certain gears provided therein.

According to what described above, device 1 comprises, in the sitting area 2, a saddle 20 on which the user is accommodated, in which said saddle 20 is in turn adjustable in a preferred position: preferably, saddle 20 comprises a vertical saddle adjustment member 25 (for the adjustment thereof along the vertical axis V-V) and a longitudinal saddle adjustment member 28 (for the adjustment thereof along the longitudinal axis X-X).

In other words, saddle 20 is also adjustable by the user according to needs in order to identify the best position possible in which to accommodate him/herself with respect to the leg rotation axis G-G and the arm rotation axis B-B.

According to a preferred embodiment, device 1 comprises a base structure 6 which extends in length along a longitudinal axis X-X to support and/or contain the sitting area 2, the leg movement means 3, the arm movement means 4 and the control means 5, according to what described above.

Preferably, the base structure 6 is such as to have the right pedal group 31 and the right handle group 41 on the right-hand side and the left pedal group 32 and the left handle group 42 on the left-hand side.

According to the preferred embodiment, the base structure 6 is substantially shaped like a box in which the inner components are contained, e.g. the exercise control means 5 and the leg 30 and arm 40 rotation shafts. Moreover, the base structure is suitable for supporting saddle 20 and the height adjustment means 45 and distance adjustment means 48 of the arm movement means 4. Preferably, saddle 20 and the height adjustment means 45 and distance adjustment means 48 are operatively connected with structure 6 in such a manner as to allow the above-described respective adjustments.

Preferably, the base structure 6 is also provided with resting legs for allowing the solid resting of device 1 on the ground plane T, and also with wheels to also allow the sliding movement thereof.

Innovatively, the above-described device for the assisted execution of a physical exercise meets the preset objects, given that it is an innovative alternative to known devices.

Advantageously, the device allows the user to execute a complete exercise which involves both the lower and the upper limbs.

Moreover, the user advantageously is not in a too probative position, so as to be able to focus his/her efforts on executing the arm and leg movement.

Moreover, the device is particularly suitable for executing a rehabilitation work. Advantageously, the electric motor group can be calibrated in dispensing power according to the needs of the user. Advantageously, the device is particularly suitable for use by persons with motor disabilities.

Advantageously, the user may use the device in manual mode and/or in electric mode, so as to better measure out his/her physical effort.

Moreover, the kinematic motion by which the arms and legs are synchronously moved advantageously is particularly safe, given that it is ensured by a respective mechanical interaction of leg movement means and arm movement means.

A further advantageous aspect lies in the fact that the device is particularly versatile given that it is adjustable in predefined positions according to physical characteristics of the user, for example his/her height and/or length of respective limbs.

Advantageously, the actuation of the device is ensured by the on-off grip. In other words, the motor group is active and operating only if the user keeps the grip in on configuration.

Moreover, through the mechanical on-off means, the grip advantageously ensures the constant turn on control to the electric motor group if the grip is grasped, and simultaneously the sudden turning off thereof as soon as the user releases his/her grasp on the grip.

Advantageously, an excellent level of safety is also ensured through the safety switch. Similarly, through the mechanical on-off means or electrical on-off means, the grip advantageously ensures the constant turn on control to the electric motor group if the grip is grasped, and simultaneously the sudden turning off thereof as soon as the user releases his/her grasp on the grip.

A further advantageous aspect of the grip lies in the fact that the problems associated with the possible presence of electrical wires, which by rotating would become twisted in the grip, are overcome. Advantageously, the mechanical on-off means and the electrical on-off means indeed do not have electrical wires subject to continuous rotation of the handle.

It is apparent that those skilled in the art may make modifications to the above-described device in order to meet contingent needs, without departing from the scope of protection as defined by the following claims.

1. A device for assisted execution of a physical exercise by a user comprising:
a sitting area in which the user is accommodated;
leg movement means comprising a right pedal group and a left pedal group, respectively accommodating the right foot and the left foot of the user to move the left foot and the right foot according to a rotatory trajectory with respect to a leg rotation axis (G-G);
arm movement means comprising a right handle group and a left handle group graspable by the user respectively with the right hand and the left hand to move the right hand and the left hand according to a rotatory trajectory with respect to an arm rotation axis (B-B) that extends parallel to the leg rotation axis (G-G);
exercise control means operatively connected to the leg movement means and to the arm movement means to transmit respective movement simultaneously.

2. Device according to claim 1, wherein the leg movement means 3 comprise a leg rotation shaft at whose ends are connected the right pedal group and the left pedal group and the arm movement means comprise an arm rotation shaft at whose ends are connected the right handle group and the left handle group, wherein the control means are operatively connected to the leg rotation shaft and to the arm rotation shaft to move the leg rotation shaft and the arm rotation shaft in rotation.

3. Device according claim 1, wherein the exercise control means comprise an electric motor group operatively connected with the leg movement means and the arm movement means to control the respective movement.

4. Device according to claim 3, wherein the control means comprise an on-off grip, housed in the right handle group and/or in the left handle group, operatively connected to the electric motor group, wherein the on-off grip is actuatable and configurable by the user, starting from an off configuration in which the electric motor group is turned off, to an on configuration in which the electric motor group is turned on and moves the leg movement means and the arm movement means.

5. Device according to claim 4, wherein the on-off grip comprises at least one button portion yieldable when pressed by the user, to be axially pushable along a grip axis (I-I), to trigger an electrical contact that controls the electric motor group.

6. Device (1) according to claim 5, wherein the on-off grip comprises at least one radial lever radially pushable by the user, to complete positioning of the grip in the on configuration.

7. Device according to claim 4, wherein the on-off grip cooperates with mechanical on-off means comprised in the exercise control means, to mechanically transmit action undergone by the button portion to engage an electrical push-button element operatively connected to the electric motor group, wherein the electrical push-button element performs a pushing action on the on-off grip.

8. Device according to claim 4, wherein the on-off grip cooperates with mechanical on-off means comprised in the exercise control means and comprising an electric collector operatively connected with an electric brush wherein the exercise control means electrically transmit action performed by the user on the grip to engage an electrical push-button element operatively connected to the electric motor group, wherein the electrical push-button element performs a pushing action on the on-off grip.

9. Device according to claim 2, wherein the control means comprise a safety switch placed in a proximal position to the arm movement means, operatively connected to the electric motor group, in such a way that, once pressed, the electric motor group is turned off and the movements of the leg movement means and of the arm movement means are blocked.

10. Device according to claim 2, wherein the control means comprise a leg transmission group comprising belts, chains or gears operatively connected to the leg rotation shaft and an arm transmission group comprising belts, chains or gears or and/or an element comprising cylindrical wheels with helical gear teeth or conical wheels, operatively connected to the arm rotation shaft, wherein said leg transmission group and said arm transmission group are operatively connected with one another.

11. Device according to claim 10, wherein the exercise control means comprise a free wheel operatively connecting the electric motor group to the leg transmission group and the arm transmission group.

12. Device according to claim 10, wherein the exercise control means comprise an encoder operatively connected to the leg transmission group to communicate with the electric motor group operatively connected with the arm transmission group.

13. Device according to claim 10, wherein the exercise control means comprise an encoder operatively connected to the leg transmission group to communicate with a secondary electric motor group operatively connected with the arm transmission group.

14. Device according to claim 10, wherein the motor group comprises a pair of brushless motors respectively operatively connected to the leg transmission group and to the arm transmission group.

15. Device according to claim 1, wherein the exercise control means comprise a flywheel element moved in rotation by the movement of the leg movement means and by the arm movement means, placed in proximity of the leg movement means, comprised in the leg transmission means.

16. Device according to claim 15, further comprising flywheel braking means operatively connected with the flywheel element and adjustable by the user to brake the movement of the flywheel and adjust resistance to the movement of the user.

17. Device according to claim 1, wherein the arm movement means comprise a height adjustment element through which is adjustable a predefined height of a position of the arm rotation axis and of the right handle group and of the left handle group.

18. Device (1) according to claim 1, wherein the arm movement means comprise a distance adjustment element through which is adjustable a longitudinal distance between the sitting area and the arm rotation axis.

19. Device according to claim 1, wherein, in the sitting area comprises a saddle on which the user is accommodated.

20. Device according to claim 19, wherein the saddle comprises a vertical saddle adjustment member and a longitudinal saddle adjustment member.

21. Device according to claim 1, comprising a base structure that extends in length along a longitudinal axis for support and/or containment of the sitting area, the leg movement means, the arm movement means and of the control means to have, on a right side, the right pedal group and the right handle group and, on a left side, the left pedal group and the left handle group.
